(19) United States
(12) Patent Application Publication
(10) Pub. No.: US 2013/0256331 A1
(43) Pub. Date: Oct. 3, 2013

(54) TABLET DISPENSER

(71) Applicants: Jean-Pierre Giraud, Auburn, AL (US); Michel Zbirka, Jouy-sur-Morin (FR); Guy De Sevaux, HW Den Haag (NL); Josephus Johannes Antonius Geboers, MA Valkenswaard (NL)

(72) Inventors: Jean-Pierre Giraud, Auburn, AL (US); Michel Zbirka, Jouy-sur-Morin (FR); Guy De Sevaux, HW Den Haag (NL); Josephus Johannes Antonius Geboers, MA Valkenswaard (NL)

(73) Assignee: TABLET DISPENSER

(21) Appl. No.: 13/702,131

(22) PCT Filed: Jun. 8, 2010
(86) PCT No.: PCT/EP10/03428

§ 371 Date: Jun. 12, 2013

(51) Int. Cl. A61J 1/03; B65D 83/04

(52) U.S. Cl. CPC A61J 1/03; B65D 83/0409
USPC 221/1; 221/277

(57) ABSTRACT

A tablet dispenser for dispensing randomly stored tablets from a bottle is disclosed. The dispenser includes offset inlet and outlet paths, a helical dispensing screw, and a rotation drive. The inlet path can be positioned for receiving a tablet to be dispensed from a bottle or other supply of tablets. The outlet path can be positioned for dispensing a tablet. The helical dispensing screw can be configured to rotate, driven by the rotation drive, to transport a tablet from the inlet path to the outlet path. The rotation drive can be operable by pushing the structure defining the inlet path and the outlet portion toward each other. The dispenser can be equipped with a dispensing sensor and memory that records data regarding each pill dispensed, such as the time of dispensing and the number of pills remaining, and optionally transmits the data to a device on or off the patient's premises.

### FIELD OF THE INVENTION

The invention relates to the field of pharmaceutics. In particular, the invention relates to a tablet dispenser, a tablet dispenser system, a use of a tablet dispenser and a method for dispensing tablets.

### BACKGROUND

The subject matter of the present invention relates to dispensers for dispensing tablets or other relatively small, uniform objects, typically one at a time, as well as to apparatus, systems, and methods for monitoring the use of such a dispenser.

See e.g., PCT application WO 2009/080309 A2, published 2 Jul. 2009, disclosing a “Device for Dispensing Solid Preparations”; Serial No. EP08171568.2, filed in the European Patent Office on Dec. 12, 2008, disclosing a “Dispenser” (and the corresponding PCT application filed Dec. 11, 2009); and U.S. Pat. No. 5,310,082.

One of the main tasks of a tablet dispenser can be to deliver one single tablet to the user of the tablet dispenser, for example a patient who will take the tablet. To this end, many tablet dispensers can be designed for separating one tablet from a bulk supply of tablets. However, in particular with non-spherical tablets, the problem can arise that a tablet gets stuck in the tablet dispenser or that more than one tablet can be dispensed during one dispensing procedure.

### SUMMARY OF THE INVENTION

A first aspect of the invention relates to a tablet dispenser for dispensing tablets from a bottle.

According to an embodiment of the invention, the tablet dispenser comprises an inlet portion with an inlet opening for receiving a tablet from the bottle; an outlet portion with an outlet opening for dispensing the tablet; a tablet transporter situated between the inlet portion and the outlet portion; and a rotation drive for rotating the tablet transporter with respect to the inlet portion and the outlet portion. For example, the tablet transporter can be an rotary tablet transporter.

The dispenser can be constructed using various packaging materials, for example thermoplastic resins, more specifically injection moldable thermoplastic resins. In an embodiment, the dispenser housing and inlet portion can be made of high density polyethylene (HDPE) or polypropylene (PP). In an embodiment, the materials desirably will provide enough structural integrity to withstand up to 100 tablet indexing cycles. In one embodiment, the inlet portion can be made out of a single material in an injection molding process. The materials optionally can protect the tablets from moisture, particularly if they are moisture-sensitive or intended to be stored in a moist environment. In another embodiment, the inlet portion or other components can incorporate an active polymer (i.e., a desiccant entrained polymer or desiccant plastic) to absorb any water vapor that enters the dispenser. For example, the inlet portion optionally can be made in a 2-shot injection molding process in which one shot can be a charge of desiccant plastic.

The rotational movement can be about an axis of rotation which, for example, can be parallel to the direction in which the bottle protrudes from the tablet dispenser. The inlet and outlet portion openings optionally are not aligned with each other, but are respectively aligned in the direction of the axis. When in use, the openings respectively can be aligned in the direction of the gravitational force, such that a tablet can fall into the openings.

According to an embodiment of the invention, the tablet transporter has a transporter pusher for receiving the tablet from the inlet opening in a receiving position of the tablet transporter with respect to the inlet and outlet portion.

According to an embodiment of the invention, the rotation drive can be adapted to rotate the tablet transporter from the receiving position to a dispensing position, thereby transporting the tablet by the transporter pusher to the outlet opening.

The transporter pusher can be a transporter opening. However, the transporter pusher can be a protrusion extending radially from the axis of rotation. For example, the pusher can comprise a shovel for receiving one tablet.

The inlet opening and the transporter opening or pusher can be aligned in the receiving position, such that a tablet can fall from the inlet opening into the transporter opening. The outlet opening and the transporter opening or pusher can be aligned in the dispensing position, such that a tablet can fall from the transporter opening or the transporter pusher into the outlet opening.

According to an embodiment of the invention, the tablet dispenser can be at least generally cylindrical-shaped.

According to an embodiment of the invention, the rotation drive can be operable by pushing the inlet portion and the outlet portion towards each other. The inlet and outlet portion can be linearly movable with respect to each other in the axis direction and the linear movement can be translated into the rotary movement of the tablet transporter, for example by a screw.

According to an embodiment of the invention, the rotational drive comprises a screw and a nut transforming a linear movement of the inlet portion and the outlet portion with respect to each other into a rotational movement of the tablet transporter. It can be possible that one of the inlet portion and outlet portion comprises one of the screw and nut and the rotation tablet transporter comprises the other of the screw and nut.

According to an embodiment of the invention, the rotational drive comprises an electrical motor for rotating the tablet transporter.

According to an embodiment of the invention, the tablet dispenser comprises a tablet transfer component for supporting the tablet during the transport from the receiving position to the dispensing position. The tablet transfer component can be situated beneath the tablet transporter. A tablet falling from the inlet opening in front of the transporter pusher or into the transporter opening can fall onto the tablet transfer component. At the position of the outlet opening, the tablet transfer component can have a opening, such that a tablet can fall out of the transporter pusher.

According to an embodiment of the invention, the tablet transporter can be lifted from the tablet transfer component during the rotational movement. This can reduce the friction between the tablet transporter and the tablet transfer component. The tablet transfer component can be separated from the tablet transporter during a dispense cycle to prevent excessive friction.

According to an embodiment of the invention, the inlet or outlet portion comprises the tablet transfer component, i. e. the tablet transfer component can be either attached to the inlet portion or to the outlet portion.

According to an embodiment of the invention, the tablet dispenser comprises a dispenser housing. The housing can be composed of polypropylene or polyethylene.

According to an embodiment of the invention, at least in the receiving position, a moisture tight seal between the bottle and the tablet dispenser can be provided. The receiving position can be the rest position in which the tablet dispenser remains most of the time. The moisture tight seal can be formed using a gasket.

According to an embodiment of the invention, the tablet dispenser comprises a spring being compressed during the movement of the tablet transporter from the receiving position to the dispensing position, wherein the spring can be adapted to move the tablet transporter from the dispensing position to the receiving position, for example by moving the inlet portion and the outlet portion away from each other. The spring can be a coil spring aligned parallel to the axis of rotation and can surround at least a part of the tablet transporter.

According to an embodiment of the invention, the inlet portion comprises a desiccant component for absorbing moisture entering the bottle from the tablet dispenser, for example from the dispensing opening.

According to an embodiment of the invention, the tablet dispenser comprises a collar adapted to be connected to a pharmaceutical bottle comprising the tablets. The pharmaceutical bottle can be a standard pharmaceutical bottle and the tablet dispenser can be used with this standard bottle. The tablet dispenser can be assembled on to a pharmacy bottle or pharmaceutical bottle containing tablets in a bulk orientation.

The tablet dispenser can be assembled on to a pharmacy bottle used by pharmacists for repackaging pharmaceutical tablets. Alternatively, the tablet dispenser can be used with a primary pharmaceutical bottle. The tablet dispenser can be disposable. Alternatively, The tablet contact portions of the tablet dispenser can be disposable and the non-tablet-contact portions of the tablet dispenser can be reusable.

According to an embodiment of the invention, the tablet dispenser comprises an anti-bridging device positioned to sweep and block an entrance to the receiving opening when the rotation drive is operated. The anti-bridging device can be attached to the inlet portion and can be rotated by the rotation drive. When being rotated, the anti-bridging device can sweep the volume above the inlet opening, to remove misaligned tablets blocking (or bridging) the inlet opening. The anti-bridging device can comprise at least one radially extending finger circumferentially sweeping the entrance to the inlet path when the rotation drive is operated.

According to an embodiment of the invention, the tablet dispenser comprises a child resistant interlock having a normally locked position for preventing a tablet from being dispensed and an unlocked position for allowing a tablet to be dispensed. The tablet dispenser can be assembled to the bottle using a child resistant closure. The tablet dispenser can incorporate a child resistant feature for the dispensing cycle.

According to an embodiment of the invention, the child resistant interlock, when in its normally locked position, can prevent the inlet portion and the outlet portion from being pushed together.

According to an embodiment of the invention, the tablet dispenser comprises an energy reservoir for providing energy to the motor for rotating the tablet transporter can be supplied with energy by the energy reservoir.

According to an embodiment of the invention, the tablet dispenser comprises a bottle. The bottle can incorporate a desiccant or a desiccant plastic to protect the tablets from moisture. A desiccant can be used that can be integrated into the walls of the bottle. The bottle walls can comprise desiccant entrained polymer or be made of desiccant entrained polymer. A molded sleeve, composed of a desiccant entrained polymer can be assembled into the bottle. The bottle comprising desiccant entrained polymer can be manufactured in a 2-shot injection molding process. Desiccants suitable for use in pharmaceutical packaging can be used, e.g. silica gels and crystalline aluminosilicates (molecular sieves).

According to an embodiment of the invention, the dispenser includes an inlet portion, an outlet portion, a tablet transporter comprising a helical dispensing screw, and a rotation drive. The inlet portion can be perforated by an inlet path. The inlet path can be formed by the inlet opening or can be the inlet opening.

According to an embodiment of the invention, the inlet path can be positioned for receiving a tablet to be dispensed from a bottle or other bulk supply of tablets.

According to an embodiment of the invention, the outlet portion can be perforated by an outlet path. The outlet path can be formed by the outlet opening or can be the outlet opening. The outlet path can be non-collinear with the inlet path and positioned for dispensing a tablet.

According to an embodiment of the invention, the helical dispensing screw can be disposed between the inlet portion and the outlet portion. The helical dispensing screw can be configured to rotate to transport a tablet from the inlet path to the outlet path.

According to an embodiment of the invention, the rotation drive rotates the helical dispensing screw from the inlet path to the outlet path and back. The rotation drive can be operable by pushing at least one of the inlet portion and the outlet portion toward the other. The rotation drive can be configured to rotate the dispensing helical dispensing screw with respect to the outlet portion for transporting a tablet from the inlet path to the outlet path.

According to an embodiment of the invention, the tablet dispenser comprises: an inlet portion perforated by an inlet path, the inlet path positioned for receiving a tablet from a bottle; an outlet portion perforated by an outlet path, the outlet path being non-collinear with the inlet path and positioned for dispensing a tablet; a helical dispensing screw disposed between the inlet portion and the outlet portion and configured to transport a tablet from the inlet path to the outlet path; and a rotation drive operable by pushing at least one of the inlet portion and the outlet portion toward the other and configured to rotate the dispensing helical dispensing screw with respect to the outlet portion for transporting a tablet from the inlet path to the outlet path.

According to an embodiment of the invention, the tablet dispenser comprises a child resistant interlock having a normally locked position for preventing a tablet from being dispensed and an unlocked position for allowing a tablet to be dispensed.

According to an embodiment of the invention, the child resistant interlock prevents the rotation drive from operating when in its normally locked position and releases the rotation drive when in its unlocked position.

According to an embodiment of the invention, the child resistant interlock, when in its normally locked position, prevents the inlet portion and the outlet portion from being pushed together.

According to an embodiment of the invention, the child resistant interlock comprises opposed apertures in the outlet portion defining outlet abutments facing the inlet portion and resilient tabs extending from the inlet portion into the apertures and having inlet abutments that normally engage the outlet abutments, the resilient tabs being movable against their resilience out of engagement with the outlet abutments to permit the inlet portion and the outlet portion to telescope toward each other.

According to an embodiment of the invention, the rotation drive comprises a first threaded portion secured to one of the inlet portion and the outlet portion and a second threaded portion secured to the helical dispensing screw, the first and second threaded portions engaging to rotate the helical dispensing screw when the first and second threaded portions are pushed together.

According to an embodiment of the invention, the rotation drive comprises a third threaded portion secured to the other of the inlet portion and the outlet portion and a fourth threaded portion secured to the helical dispensing screw for rotatably capturing the helical dispensing screw between the inlet portion and the outlet portion.

According to an embodiment of the invention, the inlet portion comprises a feed for feeding tablets to the inlet path.

According to an embodiment of the invention, the tablet dispenser comprises a spring between the inlet and outlet portions biasing the inlet and outlet portions away from each other.

According to an embodiment of the invention, the inlet portion comprises a threaded collar to receive the threaded mouth of a pharmaceutical bottle containing tablets to be dispensed.

According to an embodiment of the invention, the tablet dispenser comprises a pharmaceutical bottle on which the tablet dispenser is mounted.

According to an embodiment of the invention, the tablet dispenser comprises an external guide surface of the inlet portion leading up to the inlet path for directing tablets toward the inlet path.

According to an embodiment of the invention, the guide surface comprises an axially facing helical surface.

According to an embodiment of the invention, the guide surface comprises a radially facing helical surface.

According to an embodiment of the invention, the guide surface can be further defined by the wall of a bottle when a bottle is mounted on the tablet dispenser.

According to an embodiment of the invention, the tablet dispenser comprises a gasket to seal the contents of a bottle mounted on the tablet dispenser against the transport of moisture into the bottle.

According to an embodiment of the invention, the helical dispensing screw seats against the gasket to seal or reseal between uses and withdraws from the gasket when the helical dispensing screw rotates.

According to an embodiment of the invention, the tablet dispenser comprises a desiccant for absorbing moisture entering the bottle.

According to an embodiment of the invention, the tablet dispenser comprises an anti-bridging device movable by the rotation drive and positioned to sweep and block the entrance to the inlet path when the rotation drive is operated.

According to an embodiment of the invention, the anti-bridging device comprises two radially extending fingers circumferentially sweeping the entrance to the inlet path when the rotation drive is operated.

A further aspect of the invention relates to a tablet dispenser system.

According to an embodiment of the invention, the tablet dispenser system comprises a tablet dispenser as described in the above and in the following. The tablet dispenser system can comprise a plurality of such tablet dispensers.

According to an embodiment of the invention, the tablet dispenser system comprises a central database system exchanging information with the tablet dispenser(s).

A further aspect of the invention relates to a use of a tablet dispenser as described in the above and in the following to dispense pharmaceutical tablets.

A further aspect of the invention relates to a method of dispensing a tablet with a tablet dispenser. According to an embodiment of the invention, the method comprises the steps of: attaching a bottle storing tablets in a bulk to the tablet dispenser; receiving, in an inlet opening of an inlet portion of the tablet dispenser, a tablet from the bottle, wherein the tablet falls into a transporter pusher of a tablet transporter being in a receiving position; rotating, by a rotation drive, a tablet transporter from the receiving position to a dispensing position, wherein the tablet falls into an outlet opening of an outlet portion of the tablet dispenser, when the tablet transporter arrives at the dispensing position; dispensing the tablet from the outlet opening.

According to an embodiment of the invention, a tablet dispenser for dispensing randomly stored tablets from a bottle is disclosed. The dispenser can include offset inlet and outlet paths, a helical dispensing screw, and a rotation drive. The inlet path can be positioned for receiving a tablet to be dispensed from a bottle or other supply of tablets. The outlet path can be positioned for dispensing a tablet. The helical dispensing screw can be configured to rotate, driven by the rotation drive, to transport a tablet from the inlet path to the outlet path. The rotation drive can be operable by pushing the structure defining the inlet path and the outlet portion toward each other.

Other aspects, embodiments, and features of the present development will be apparent upon review of the present description.

### BRIEF DESCRIPTION OF DRAWING FIGURES

FIG. 1 shows tablets which can be dispensed by an embodiment of a tablet dispenser.

FIG. 2 is a perspective view of an embodiment of a dispenser.

FIG. 3 is an exploded view of the dispenser.

FIG. 4 is a flow diagram for a method for dispensing tablets.

FIG. 5 is a longitudinal section taken along section lines A-A of FIG. 2, showing interior structure of the dispenser.

FIG. 6 is a longitudinal section taken along section lines B-B of FIG. 2, showing interior structure of the dispenser.

FIG. 7 is an isolated longitudinal section, similar to FIG. 6 but turned upright, of a conventional pharmaceutical bottle identified as prior art.

FIG. 8 is an isolated perspective view of the dispensing funnel or inlet portion.

FIG. 9 is a cross-section of the dispenser.

FIG. 10 is a cutaway perspective view of the dispenser, showing the interior of the cover 65.

FIG. 11 is an isolated perspective view of the helical dispensing screw.

FIG. 12 is a perspective assembly view of the dispenser, with the bottle removed.

FIG. 13 is a diagrammatic view of a block diagram of the electronic circuit in accordance with an embodiment of the invention.

FIG. 14 is a diagrammatic view of a system for communicating with a dispenser in accordance with an embodiment of the invention.

FIG. 15 is a diagrammatic view of a block diagram of an electronic reader-writer device in accordance with an embodiment of the invention.

FIG. 16 is a diagrammatic view of therapy compliance monitoring and communication equipment in accordance with an embodiment of the invention.

FIG. 17 is a diagram showing the equipment of a Near Field Communication data exchange format in accordance with an embodiment of the invention.

The reference characters used in the description and the drawings, and their meanings, are listed in summary form in the list of reference characters. In principle, like reference characters indicate like or corresponding parts.

### DETAILED DESCRIPTION

The description of illustrated embodiments and variations in this specification is only illustrative of the many embodiments of the invention within the scope of one or more of the claims. The inventors do not intend to limit the scope of the claims by reference to specific embodiments, unless done expressly.

A unit dose dispensing device is disclosed.

The unit dose dispenser can be used with specialized generics or used in combination with a branded drug.

The dispenser can be used by health care facilities such as hospitals, nursing homes, and assisted living facilities to improve compliance and more efficiently dispense medication.

The dispenser can be fitted onto a standard pharmaceutical or pharmacy bottle.

“Tablets” or “pills” as referred to here are merely exemplary of any such objects to be dispensed, and not a limitation on the items dispensed. It shall be noted that whenever in the above and following reference is made to a tablet, capsule or pill, this shall explicitly be understood as being applicable for solid preparations in general, and pharmaceutical, nutritional or confectionary dosage forms in particular, like pills, capsules, tablets, granulate, dragees, lozenges, suppositories, or other uniform solid dosage forms, or other discrete objects of any kind; the solid preparations having the spatial dimensions of a tablet, capsule or pill, e.g. the size and/or shape of a tablet, capsule or pill, in particular tablets, capsules and pills themselves being preferred. The dispenser can be configured to support a range of tablet sizes and shapes, such as circular, oblong, or irregularly shaped. In an embodiment, the tablets can range in size from 4.0 mm to 20.0 mm in diameter.

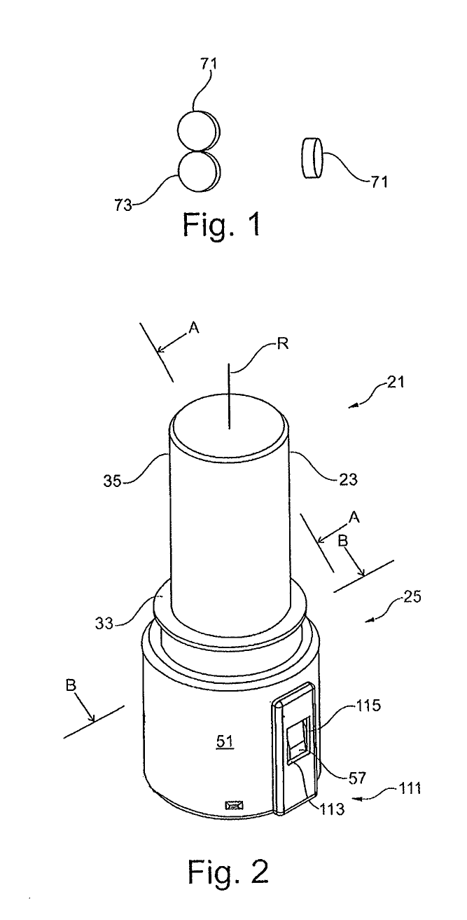

Referring to the drawing figures, FIG. 1 shows tablets 71, 73 that can be used with the tablet dispenser 25 shown in FIG. 2. The tablets 71 and 73 shown in FIG. 1 are generally circular in shape and can have a nominal diameter of 11.0 mm and a thickness of 5.0 mm. These shapes and dimensions are exemplary.

Referring to FIG. 2, a tablet dispenser and bottle assembly 21 is shown, including a bottle 23 and a dispenser 25 for dispensing tablets 71, 73 from the bottle 23. The dispenser 25 can be threaded onto the bottle 32. Alternatively, the bottle 23 can be replaced by a receptacle of any type for tablets, capsules, pills, lozenges, suppositories, or other uniform solid dosage forms, or other discrete objects of any kind.

The tablet dispenser 25 can be cylindrical in shape and comprises a housing 51. In the housing 51, a dispensing mechanism and electronics are packaged.

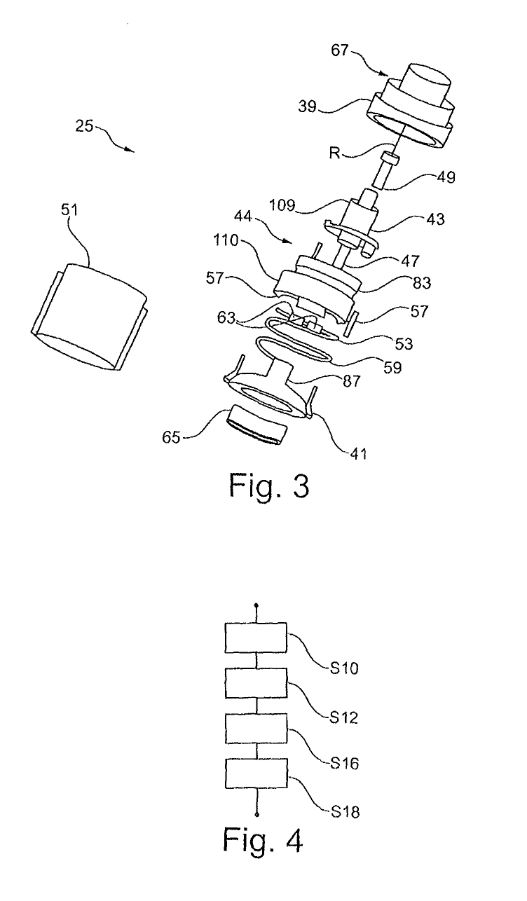

FIG. 3 shows an exploded view of the tablet dispenser 25 with the housing 51 removed. The tablet dispenser 25 comprises a inlet portion 39 or dispensing funnel 39, an outlet portion 41 and a tablet transporter or helical dispensing shaft 43 situated between the inlet portion 39 and the outlet portion 41. The tablet transporter 43 is rotatable about an axis R with respect to the inlet portion 39 and the outlet portion 41. The inlet portion 39 and the outlet portion 41 are linearly movable with respect to each other along the axis R.

A spring 53 bears against a child resistant component 110 connected to the inlet portion 41 and bears against the outlet portion 41. The spring 53 acts against the movement of the inlet portion 39 and the outlet portion 41.

The tablet transporter 43 has a screw 47 engaging into a nut 45 (not visible in FIG. 3) of the outlet portion 41. When moving the inlet portion 39 in the direction of the outlet portion 41, the screw 47 can be threaded into the nut 45 and thus rotates the tablet transporter 43. The screw 47 can be the rotating part 47 and the nut 45 the stationary part 45 of a rotation drive 44 of the tablet dispenser 25.

A tablet transfer component 83 can be situated between the child resistant component 110 and the tablet transporter 43 and can provide a bearing for the tablet transporter and a tablet that is transported by the tablet transporter.

An anti-bridging device 49 for sweeping tablets can be attached to the upper part of the tablet transporter 43 and rotates together with the tablet transporter 43.

The child resistant component 110 has two tabs 57 adapted to engage into abutments 113 of the housing 51 (see FIG. 2) and, when engaged, preventing the movement of the inlet portion 39 in the direction of the outlet portion 41. The tabs 57 and the abutment 113 form a child resistant interlock 111.

A battery cover 65 can be attached to the bottom side of the outlet portion 41. The battery cover 65 houses two batteries 63 providing electrical energy to an electronics mounting disk 59 attached to the upper side of the outlet portion 41.

FIG. 4 shows a flow diagram for a method of dispensing tablets.

In a step S10, the tablet dispenser 25 can be positioned for use with the housing 51 facing downward as shown in FIG. 2. The tablets 71, 73, located in the bottle 23 in a bulk configuration are directed toward an entry funnel, inlet path or inlet opening 67 within inlet portion 39 of the tablet dispenser 25. The inlet path 67 permits one tablet 71 to enter the tablet dispenser 39, into a transporter opening 109 of the tablet transporter 43. In a step S12, optionally, the child resistant interlock 111 must be depressed by the user so that the tablet 71 can be dispensed. The two buttons 57 on either side of the tablet dispenser 25 are depressed to release the child resistant interlock 111.

In a step S14, the user presses down on the bottle 23 to dispense a tablet. The downward motion causes the spring 53 within the dispenser 25 to compress and simultaneously, the tablet transporter 43 to rotate 90-degrees, this rotation moving the tablet in the transporter opening 109 on the tablet transfer component 83 to an outlet opening 87 of the outlet portion 43. More generally, instead of the opening 109, the tablet transporter 43 can comprise a protrusion or pusher for moving the tablet to the outlet opening 87.

In a step S16, the tablet falls by gravity out of the dispenser 25.

In a step S18, when the user removes the downward force on the bottle 23, the stored energy in the spring 53 returns the tablet transporter 43 to the original receiving position (i.e., the tablet transporter 43 rotates back).

To dispense a second tablet, the dispenser 25 can be adapted to require shaking or rotation into the upright and then the inverted positions to enable the next tablet to enter dispensing funnel. The anti-bridging device 49 can ensure that only one tablet enters the dispensing funnel.

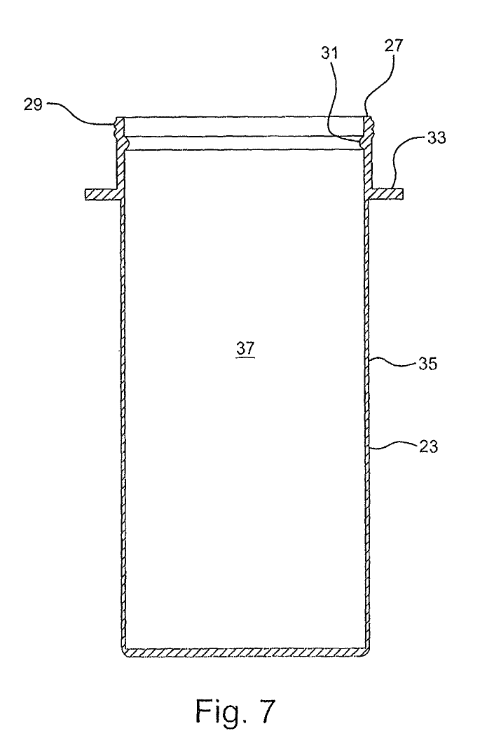

Referring briefly to FIG. 7, the bottle 23 as illustrated can be a conventional pharmaceutical bottle comprising a mouth 27 having one or more threads 29 for receiving a threaded cap (defining a threaded mouth), an interior bead 31 to make the mouth 27 more rigid, an exterior flange 33 to stiffen the bottle 23 or serve as a stop to limit the travel of a cap (or both, or neither), and a wall generally indicated as 35 enclosing a reservoir 37 adapted for containing multiple tablets or other uniform discrete objects to be dispensed. The dispenser 25 can be threaded onto the bottle 23. In one embodiment, the dispenser 25 can be attached to the bottle 23 with a child-resistant closure system. One commonly used child-resistant closure for a bottle can be a push-and-turn style. Another commonly used child-resistant closure aligns an arrow on the closure with an arrow on the bottle. When the arrows are aligned, the closure can be removed readily. These types of childproof closures are exemplary.

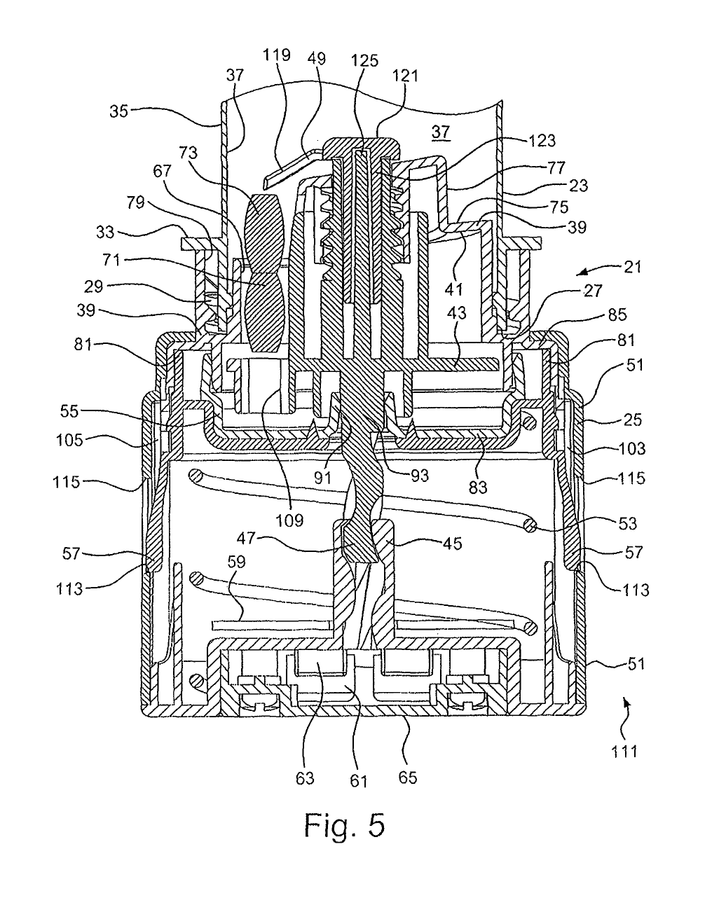

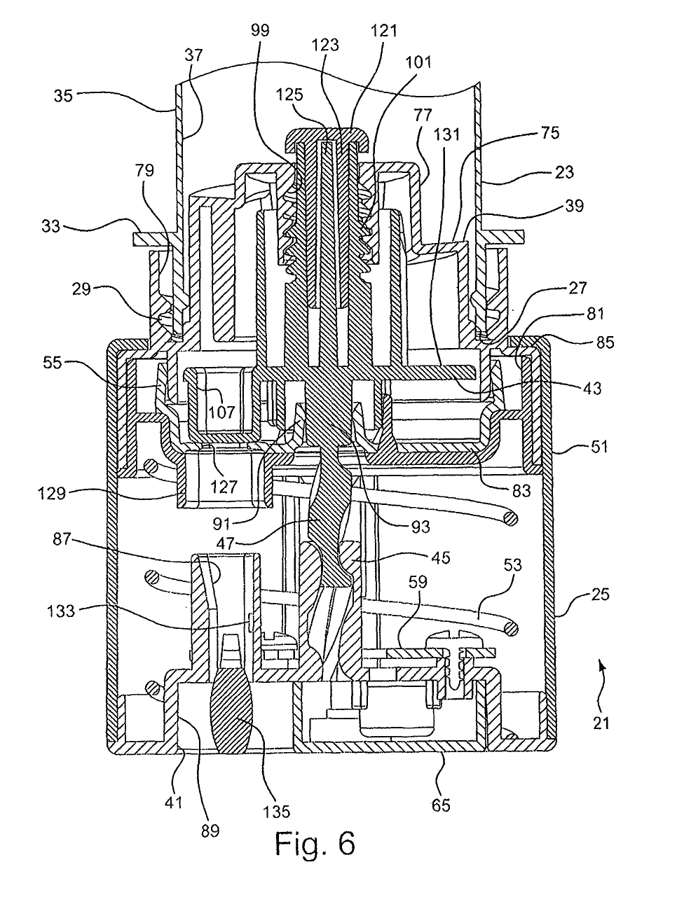

Referring now mainly to FIGS. 5 and 6, the dispenser 25 includes an inlet portion or dispensing funnel 39, an outlet portion 41, a helical dispensing screw 43, and a rotation drive 44, here comprising a first threaded portion 45 secured to and here integral with the outlet portion 41 and a second threaded portion 47 secured to and here integral with the helical dispensing screw 43. The embodiment shown in the figures further comprises an anti-bridging sweep 49 or anti-bridging device 49, a body or shell or housing 51, and a spring 53 (which in an alternative embodiment can be any resilient body, such as a block or other shape of resilient foamed plastic). The illustrated dispenser 25 also can include a slide surface or pan 55 which guides tablets during rotation of the helical dispensing screw 43 (as further explained below) and a tab assembly 57 interacting with the body 51 to provide a child resistant interlock 111. The dispenser 25 can have an electronics mounting disk 59 for mounting electronic components as further described below and one or more (here, two) battery holders such as 61 to hold one or more batteries such as 63 for powering the electronics and any other powered devices. The dispenser 25 as illustrated has an inset cover 65 to provide a finished appearance and retain the batteries 63 and other parts in place.

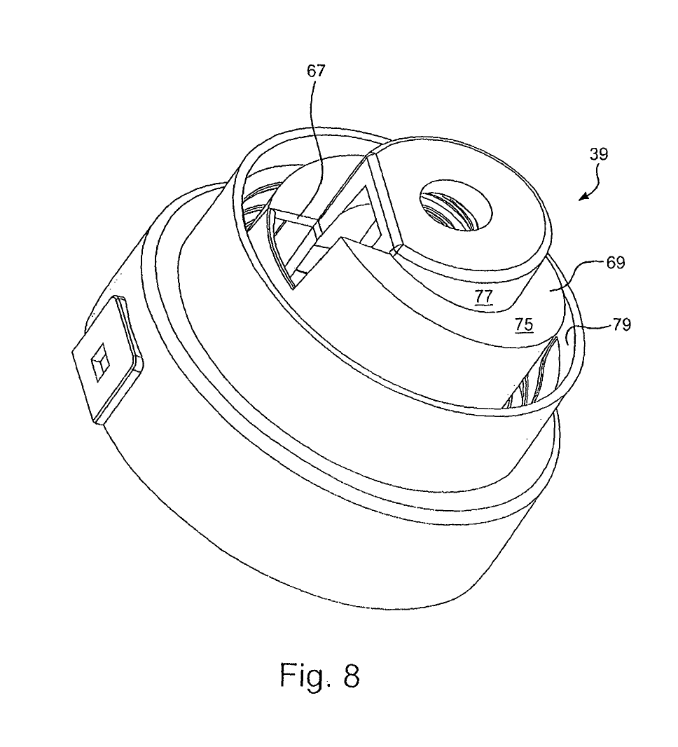

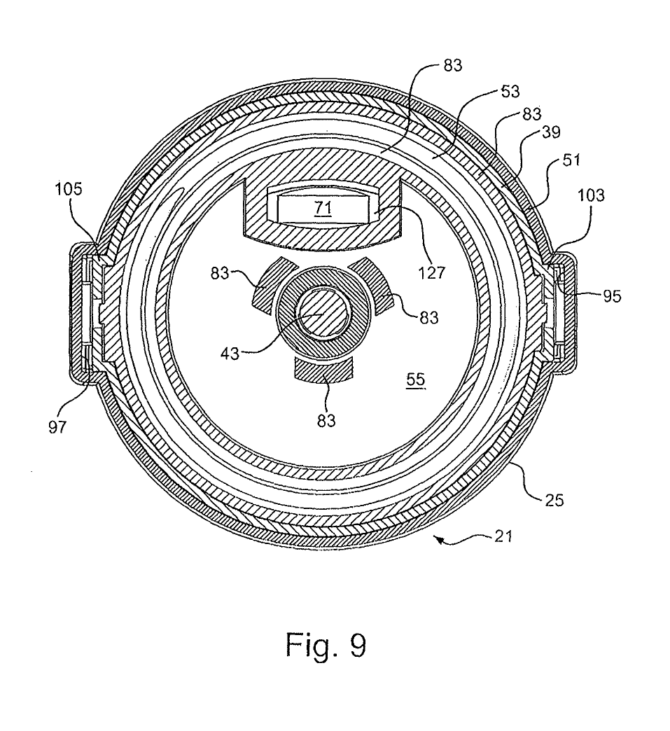

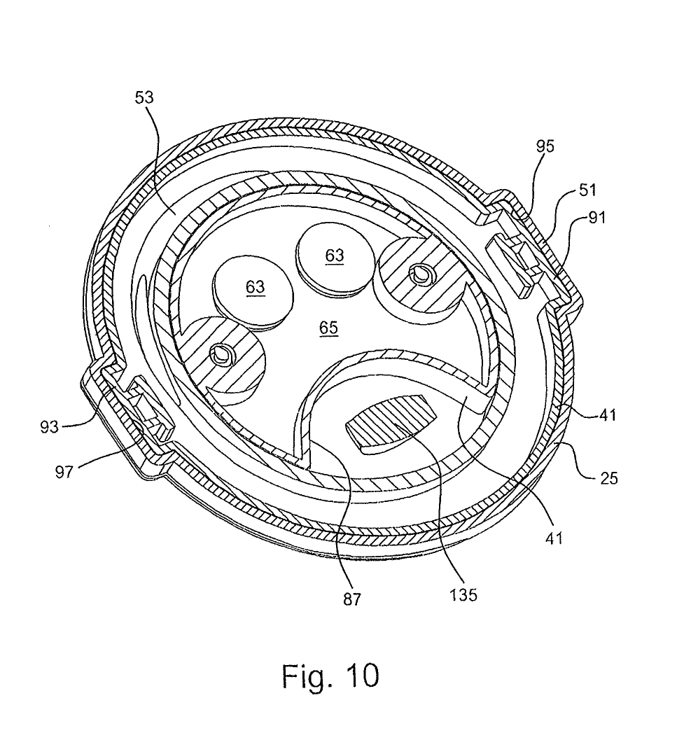

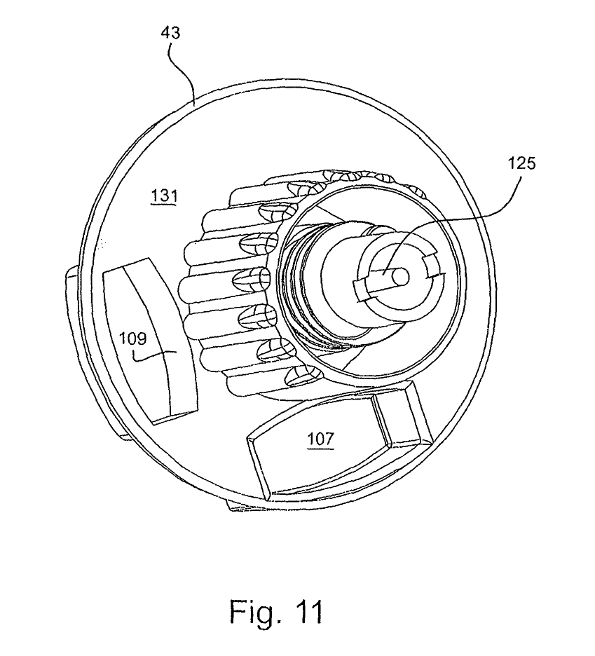

The inlet portion 39 can be perforated by an inlet path or inlet opening 67. The inlet path 67 can be positioned for receiving a tablet to be dispensed from a bottle 23 or other supply of tablets. The inlet portion 39 of the dispenser 25 can include a feed generally indicated as 69 (FIG. 8) for feeding tablets such as 71 and 73 (FIG. 2) to the inlet path 67.

Referring now to FIG. 8, the tablet dispenser 25 can have an external guide surface or feed 69 of the inlet portion 39 leading up to the inlet path 67 for directing tablets toward the inlet path 67. For example, the guide surface 69 can include a generally axially facing helical surface 75 leading up to or forming a part of the inlet path 67. The guide surface 69 can include a generally radially facing helical surface 77. In an embodiment, the guide surface 69 can be further defined by the wall 35 of a bottle 23 that can be generally parallel to the radially facing helical surface 77 and located on the other side of the axially facing helical surface 75 when a bottle 23 is mounted on the tablet dispenser 25 with its mouth 27 threaded into the collar or groove 79.

The tablet dispenser 25 can include a gasket 81 bearing against the shoulder 85 of the inlet portion 39 to seal against the transport of moisture into the bottle 23. The gasket 81 can be formed integral with the child resistant component 110. The gasket 81 also seats against the tablet transfer component 83, and the tablet transfer component 83 has a flange 91 that seats against the spindle 93 of the helical dispensing screw 43. The child resistant component 110 with the gasket 81 further includes a chute 129 that seats against the pocket 107 when the dispenser 25 is in its rest position. In one embodiment the gasket 81 can be made of a thermoplastic elastomer; an example of a suitable elastomer is ethylene propylene diene monomer rubber (EPDM).

The tablet transfer component 83 also supports the child resistance component 110 with tabs 57 described above; contrary to the illustrated embodiment, the tablet transfer component 83 and the child resistance component 110 can be integral, though they could also be provided as independent parts. The tablet dispenser 25 can include a desiccant, either inside a connected bottle 23 or inside the dispenser 25 itself, for absorbing moisture entering the bottle 23 or from the bottle 23. The tablet dispenser can comprise a desiccant entrained polymer. Parts of the tablet dispenser can be made of a desiccant entrained polymer.

The outlet portion 41 of the dispenser 25 can be perforated by an outlet path or outlet opening 87, here further defined by an outlet chute 89 of the outlet portion 41. The outlet path 87 can be non-collinear with the inlet path 67 and can be positioned for dispensing a tablet. The tablet dispenser 25 optionally can include a spring 53 between the inlet and outlet portions 39 and 41 for normally biasing the inlet and outlet portions 39 and 41 away from each other.

The helical dispensing screw 43 can be disposed between the inlet portion 39 and the outlet portion 41. The helical dispensing screw 43 can be configured to rotate to transport a tablet from the inlet path 67 to the outlet path 87. The rotation drive 44 rotates the helical dispensing screw 43 from the inlet path 67 to the outlet path 87 and back. The rotation drive 44 can be operable, in an embodiment, by pushing at least one of the inlet portion 39 and the outlet portion 41 toward the other. The rotation drive 44 optionally can be configured to rotate the dispensing helical dispensing screw 43 with respect to the outlet portion 41 for transporting a tablet from the inlet path 67 to the outlet path 87.

The rotation drive 44 can include a first threaded portion 45 or nut 45 secured to one of the inlet portion 39 and the outlet portion 41. In the illustrated embodiment the first threaded portion 45 can be formed integrally with the outlet portion 41. The rotation drive 44 can include a second threaded portion 47 or screw 47 secured to (and as illustrated formed integrally with) the helical dispensing screw 43. In an embodiment, the first and second threaded portions 45 and 47 can engage each other to rotate the helical dispensing screw 43 when the first and second threaded portions 45 and 47 are pushed together.

The rotation drive 44 can also include a third threaded portion 99 secured to the other of the inlet portion 39 and the outlet portion 41 (compared to the first threaded portion 45), and here integral with the inlet portion 39. A fourth threaded portion 101 can be secured to the helical dispensing screw 43 for rotatably capturing the helical dispensing screw 43 between the inlet portion 39 and the outlet portion 41. The inlet portion 39 can be prevented from rotating while allowed to translate axially relative to the body 51. The inlet portion 39 can be so constrained by its ears 103 and 105 received in the grooves 95 and 97 of the body 51. The helical dispensing screw 43 further comprises a pocket 107 and a chute 109 or transporter opening 109.

In the illustrated embodiment, the pitch of the threads 45 and 47 engaging the helical dispensing screw 43 with the outlet portion 41 can be different from, and as illustrated here greater than, the pitch of the threads 99 and 101 engaging the helical dispensing screw 43 with the inlet portion 39. Also, the inlet portion 39 can be allowed to translate axially relative to the body 51. As a result, in the illustrated embodiment, telescopically advancing the outlet portion 41 toward the inlet portion 39 simultaneously rotates the helical dispensing screw 43 and withdraws the helical dispensing screw 43 up (as shown in FIGS. 5 and 6) away from the child resistance component 110 with gasket 81 and away from the tablet transfer component 83, in this embodiment by about 1 mm. This 1 mm separation enables the dispenser mechanism to rotate without excessive friction between the gasket 81, the tablet transfer component 83 and the helical dispensing screw 43.

The tablet dispenser 25 optionally can include a child resistant interlock 111 having a normally locked position (illustrated in the Figures) for preventing a tablet from being dispensed and an unlocked position for allowing a tablet to be dispensed. Referring to FIGS. 2 and 5, the child resistant interlock 111 includes the tabs 57 of the tablet transfer component 83 bearing against the abutments 113 of the body 51 and the gasket 81 of the tablet transfer component 83 bearing against the shoulder 85 of the inlet portion 39. As shown in FIG. 5, the child resistant interlock 111 can operate by preventing the inlet portion 39 and the outlet portion 41 from being pushed together when the child resistant interlock 111 can be in its normally locked position. Preventing the inlet portion 39 and the outlet portion 41 from being pushed together also prevents the rotation drive 44 from operating.

To release the interlock 111, the opposed tabs 57 can be pressed toward each other with two fingers of one hand to release the tabs 57 from the abutments 113. Access to the tabs 57 can be provided by the apertures such as 115 (FIG. 2). This releases the inlet portion 39 to move axially toward the outlet portion 41, allowing the rotation drive 44 to operate. This can be a child resistant interlock 111, particularly because the tabs 57 must both be held out of engagement with the abutments 113 and the body 51 must be telescoped on the inlet portion 39 at the same time to cause the dispenser 25 to operate.

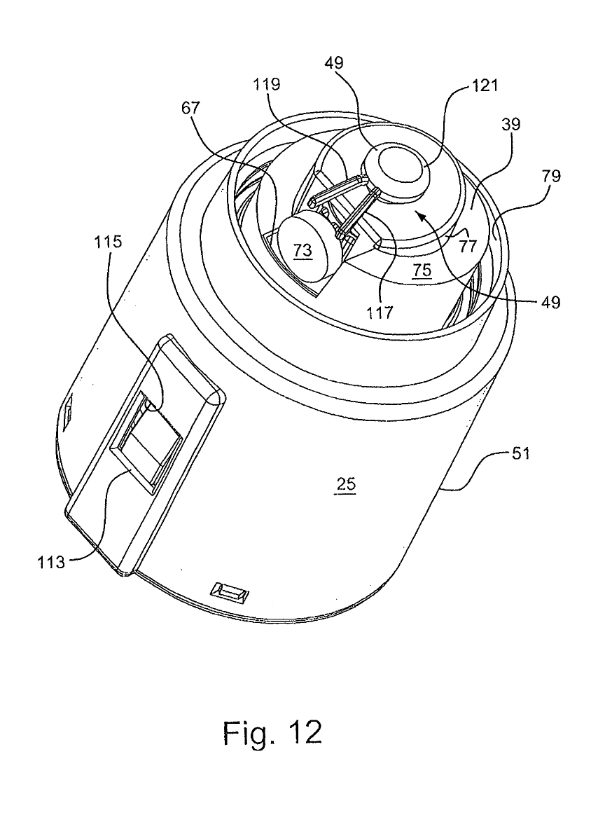

The tablet dispenser 25 can include an anti-bridging device such as 49 movable by the rotation drive 44 and positioned to sweep and block the entrance to the inlet path 67 when the rotation drive 44 is operated. In the illustrated embodiment, best illustrated in FIGS. 5 and 12, the anti-bridging device 49 takes the form of two fingers 117 and 119 mounted to a hub 121. The hub 121 has a depending root 123 engaging a second spindle 125 of the helical dispensing screw 43.

The dispenser 25 can be constructed using various packaging materials, for example thermoplastic resins, more specifically injection moldable thermoplastic resins. In an embodiment, the dispenser housing 51 and funnel 39 can be made of high density polyethylene (HDPE) or polypropylene (PP). In an embodiment, the materials desirably will provide enough structural integrity to withstand up to 100 tablet indexing cycles. In addition, the materials and construction optionally can be such as to enable the dispenser 25 to be dropped from a distance of one meter onto a hard surface without sustaining damage. In one embodiment, the inlet portion 39 can be made out of a single material in an injection molding process.

The materials optionally can protect the tablets from moisture, particularly if they are moisture-sensitive or intended to be stored in a moist environment. In another embodiment, the inlet portion 39 or other components can incorporate an active polymer (i.e., a desiccant entrained polymer or desiccant plastic) to absorb any water vapor that enters the dispenser assembly 21. For example, the inlet portion 39 optionally can be made in a 2-shot injection molding process in which one shot can be a charge of desiccant plastic. The materials desirably can have a low moisture vapor transmission rate to protect the tablets in the bottle and dispenser from exposure to moisture.

FIGS. 2 and 5 show the device at rest. When the mechanism is operated to rotate the helical dispensing screw 43, this sweeps the fingers 117 and 119 counter-clockwise as shown in FIG. 12, clearing the tablet 73 which can be partially within the inlet path 67 but sweeping away higher tablets along the axial facing helical surface 75. The fingers 117 and 119 sweep about 90 degrees in the illustrated embodiment. Releasing the dispenser 25 returns the mechanism to its rest position (for example, the receiving position). In their rest positions, the fingers 117 and 119 block further tablets from stacking on the tablet 73.

The dispenser 25 therefore operates as follows. FIG. 5 shows the assembly 21 oriented for dispensing a tablet. Referring to FIGS. 5 and 6, in the receiving position of the dispenser 25, a tablet 71 typically slides down the surface 75 and drops along the inlet path 67 into the chute 109. At this point the tablet 71 can be supported on the slide surface 55. A second tablet 73 (if present) will in some instances fall with the tablet 71, and (if so) can be supported on the tablet 71 just above the level of the chute 109. The dispense function can be carried out by holding in the tabs 57 against their resilient bias to clear the abutments 113 and at the same time pushing down on the bottle 23 while the body 51 is supported on a counter or other surface. Pushing down on the bottle 23 against the bias of the spring 53 telescopes or advances the inlet portion 39 toward the outlet portion 41. This action causes the rotation drive 44 to turn the helical dispensing screw 43 about a quarter turn (in this embodiment: the degree of rotation can be changed readily by rearranging the parts), moving the tablet 71 “out of the sheet” and in front of the spindle 125 to the position shown in FIG. 6, i. e. into the dispensing position of the dispenser 25. In another embodiment the dispensing function can be performed automatically by incorporating a DC motor to rotate the helical dispensing screw 43. The motor can be activated, for example, when the user presses down on the dispenser and can supplied with electrical energy by the batteries 63.

Referring to FIGS. 5 and 6, rotation of the helical dispensing screw 43 rotates the chute 109 of the helical dispensing screw 43, carrying the tablet 71, into alignment with an opening 127 through the slide surface 55. The opening 127 also can be in alignment with the chute 129 of the gasket 81. The tablet 71 thus drops through the opening 127 and the chute 129 into the outlet path or opening 87 and out of the dispenser under the influence of gravity.

Meanwhile, the second tablet 73 shown in FIG. 5 remains in the inlet path or chute 67 and can be supported against axial advance by the rotating surface generally indicated at 131 of the helical dispensing screw 43. When the dispensing mechanism is returned to its initial position, the tablet 73 drops to the position formerly occupied by the tablet 71 as shown in FIG. 5. Also, in the rest position the pocket 107 of the helical dispensing screw 43 blocks the chute 129, preventing tablets from being inserted into the outlet path 87 when the dispenser is upright (inverted compared to FIGS. 2, 5 and 6). It is contemplated in the illustrated embodiment that, to dispense a third tablet (not shown), the dispenser 25 can be shaken or rotated into the upright and then the inverted positions (the inverted position is that of FIGS. 2, 5 and 6) to enable the next tablet to enter the inlet path 67.

Additionally, when the inlet portion 39 is advanced axially relative to the outlet portion 41, the helical dispensing screw 43 moves axially away from the inlet portion 39 due to the engagement of the third and fourth threaded portions 99 and 101 as the helical dispensing screw 43 turns. This brings the chute 109 axially nearer to the opening 127 in the slide surface 55, facilitating dispensing.

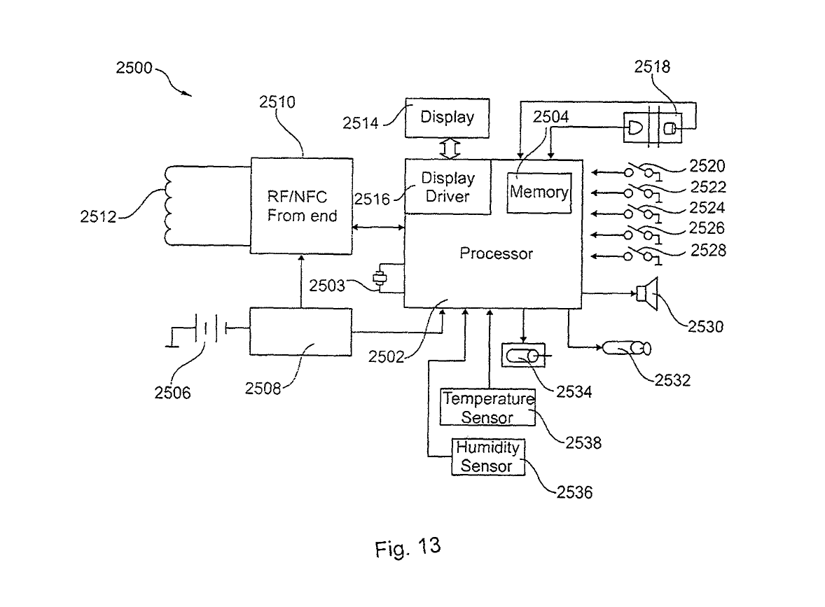

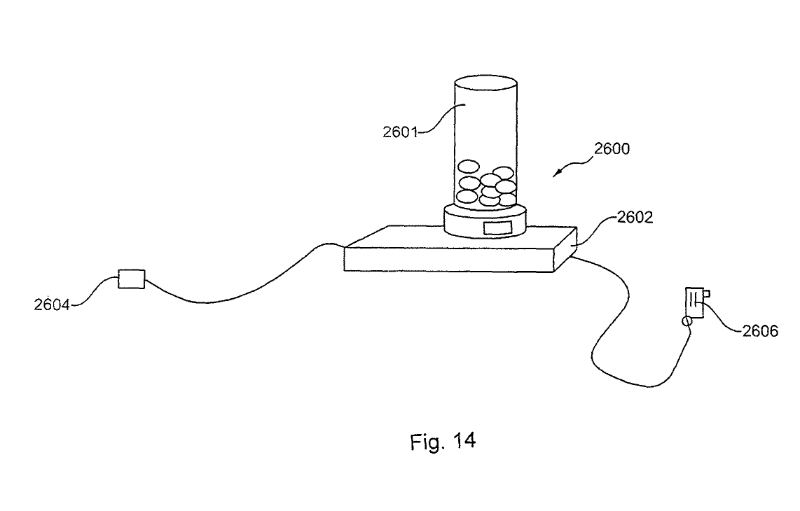

FIG. 13 shows a block diagram of another embodiment of an electronic circuit 2500 useful for monitoring and controlling administration of medications in the above dispenser and for communication. The following text and FIGS. 14-18 originate in the PCT application PCT/EP2009/008898 filed Dec. 11, 2009, claiming the priority of EP 08 171 568.2 and EP 08 171 578.1, filed in the European Patent Office on Dec. 12, 2008.

The electronic circuit 2500 of FIG. 13 includes a processor 2502, which may, for example, be an 8-bit microcontroller, such as a P89LPC936, developed by Philips and available from NXP Semiconductors Netherlands B.V. Other processors or microcontrollers can also be used in the electronic circuit 2500. Optionally, the processor 2502 can be clocked by an external clock or crystal 2503.

The processor 2502 can include a memory 2504, for storing programmed instructions for the processor 2502 and/or data used by the electronic circuit 2500. Alternatively, the memory 2504 can include one or more external memory devices (not shown). The memory 2504 can include a non-volatile memory, such as flash memory, EEPROM memory, or static memory, and/or a volatile memory, such as DRAM.

The electronic circuit 2500 can be powered by a battery 2506, which can have its electrical characteristics adapted to the needs of the electronic circuit 2500 by a power regulator 2508. The battery 2506 can be a conventional replaceable battery, or a rechargeable battery, which can be recharged, for example, when the device is connected to a docking station (see below). The power regulator 2508 can also include the ability to detect the status of the battery 2506, and provide the status information to the processor 2502. Optionally, an additional battery measuring device (not shown) can be used to measure the status of the battery 2506.

The processor 2502 communicates with a first transceiver 2510, which communicates wirelessly with other electronic devices via a first antenna 2512. The first transceiver 2510 uses radio frequency (RF)-based communication, such as Near Field Communication (NFC) or other wireless communication technologies suitable for short-range and/or low-power wireless communication, such as other RFID technologies, Bluetooth®, or ZigBee®. Where power considerations permit longer range communications, other wireless communications technologies, such as Wi-Fi, WiMAX®, or various cellular technologies can be employed.

Optionally, where the device includes an optional display 2514, the processor 2502 can further include a display driver 2516, to operate the display 2514. Optionally, the display driver 2516 can be implemented at least in part as driver software. Optionally, the display driver 2516 can be a separate device (not shown), rather than being included in the processor 2502.

As discussed above, in dispenser embodiments, an optical detector 2518, such as a laser detector, an LED and detector, an infrared LED and detector, or other opto-electronic detection device, can be used to determine when a solid preparation, such as a pill, has been dispensed by the device. A signal from the optical detector 2518 can be provided to the processor 2502 for evaluation. Optionally, where there are multiple optical detectors (not shown), such as where there are multiple dispensing paths for pills, in which case one such detector can be present in each such path, signals from each of these the optical detectors are provided to the processor 2502.

The electronic circuit 2500 can also include numerous control switches for adjusting the settings of the processor 2502 and/or of the electronic circuit 2500. For example, a first switch 2520 can be used to activate or deactivate the electronic monitoring and communication. A second switch 2522 can be used to detect opening of the container, such as by removing or opening the container lid, or removing the dispenser from the container. In some dispenser embodiments, this can indicate tampering with the dispenser. Third and fourth switches 2524 and 2526 can be used, for example, for setting the time in hours (third switch 2524) and minutes (fourth switch 2526). A fifth switch 2528 can be used to select use of an audible alarm, such as a buzzer 2530, which can be sounded when, for example, a patient has forgotten to dispense a medication at the time that he is supposed to take it, or when optional temperature and/or humidity sensors indicate that the medication is being improperly stored. It will be understood that, depending on the user interface needs of the embodiment, the control switches can be assigned to other functions.

The electronic circuit 2500 can also optionally include alarm devices, such as the buzzer 2530 and/or a vibration device 2532. These alarm devices can be activated by the processor 2502 separately or in unison, to alert a user to a variety of conditions. Optionally, the buzzer 2530 can be controlled to produce a variety of different sounds to alert a user to various conditions. For example, one sound can be used to warn the user that he should take a dose of a medication, another sound can be used to warn the user that he is attempting to dispense additional medication before it is safe to take another dose, a further sound can be used to warn the user that the medication in the container is running low, another sound can be used to indicate that the battery is low, and still another sound can be used to indicate to the user that temperature and/or humidity sensors are indicating that the medication is not being properly stored. Optionally, the buzzer 2530 can be a small speaker, capable of producing sounds including buzzing noises, speech, musical tones, or other sounds, depending on the message to be conveyed to the user.

The timing of the sounds or vibrations produced by the buzzer 2530 and/or vibration device 2532 can be controlled by the processor 2502 to convey particular meanings or warnings. For example, the processor 2502 can be programmed to use the buzzer 2530 to produce a warning sound at a predetermined time after the solid preparation should have been dispensed. For example, a short beep could be generated every minute during one hour following the time when the solid preparation should have been dispensed. The processor 2502 can be programmed to cease such warnings when the solid preparation has been dispensed through the dispenser.

The processor 2502 can be programmed to use the vibration device 2532 in a similar manner. For example, the vibration device 2532 can be switched on for one second at the time that the solid preparation should be dispensed. This can be repeated, for example, sixty minutes later, if the solid preparation is not dispensed.

Optionally, the electronic circuit 2500 can optionally be connected to a blocking mechanism 2534. When activated, the blocking mechanism 2534 prevents the dispenser from dispensing a solid preparation. This can be achieved, for example, by sending electrical signals to a motor or solenoid to move a stopper notch between a locked and an unlocked position, as described above. The blocking mechanism 2534 can be used, for example, to prevent a user from dispensing a further dose of a medication during a time period over which a further dose is not needed or could be dangerous, or from dispensing medication which can have been damage by exposure to temperatures or humidity levels outside of an acceptable range.

Optionally, the electronic circuit 2500 can further include additional sensors, such as a humidity sensor 2536 and/or a temperature sensor 2538, positioned in such a way that they are able to detect the humidity and/or temperature of the pills, capsules, or other solid preparations stored in the dispenser device. The humidity sensor 2536 may, for example, be a capacitive humidity sensor, a resistive humidity sensor, a thermal conductivity humidity sensor, or other suitably small, commercially available electronic humidity detection device. Similarly, the temperature sensor 2538 can be a thermistor or other resistance temperature detector, or any other suitably small, commercially available electronic temperature detector. These sensors should be positioned so that they measure the temperature and/or humidity of the pills, capsules, or other solid preparations stored in the container, bottle, or dispenser.

In dispenser embodiments, the electronic circuit 2500 can be configured to fit within a portion of the dispenser mechanism, and can be built onto the electronics disk 59, as shown in earlier figures above. The electronic circuit 2500 can also be built into other portions of a medication container or bottle. For example, the electronic circuit 2500 can be built into the lid or the base of a medication bottle. Individual components of the electronic circuit 2500 can be built into other portions of the dispenser, depending on their function. For example, the humidity detector 2536 and temperature detector 2538 can be positioned so that they measure the humidity and/or temperature in the locations where pills, capsules, or other solid preparations are stored, such as the bottle 23 shown in preceding figures and discussed above.

In addition to the features described above, the electronic circuit 2500 and/or medication container or dispenser can include an identity detection device (not shown). Such an identity detection device can be connected to the electronic circuit 2500 to permit the user of the dispenser or medication container to be identified. An example of such an identity detection device can be a fingerprint reader and identifier. The processor 2502 can be programmed to accept signals from such a fingerprint reader (not shown), and to activate the dispenser or allow opening the medication container only when the fingerprint read by the fingerprint reader matches a stored fingerprint. The stored fingerprint can be stored in the memory 2504, or in a memory associated with the fingerprint reader (not shown). Since fingerprints are unique, the fingerprint of the authorized user of the device can be stored, so that only the authorized user of the device is able to activate the dispenser and to dispense a solid preparation. Other identity detection devices could also be used, including other (preferably small/portable) biometric devices, or security measures such as requiring the user to enter a combination or a personal identification number (PIN).

By adding such an identity detection device to the electronic circuit 2500, an identity function can be implemented for the dispenser or medication container. This identity function makes it possible that only an authorized or intended user, such as the patient or a caregiver, can activate the dispenser or open the medication container. Using this feature, the solid preparation could not be accessed, for example, by a child who finds the device. Additionally, the identity function can reduce the risk of taking the wrong medication, for example if there are several such dispensers or containers being used by different people in a single household.

Further, the electronic circuit 2500 can be connected to an RFID reader (not shown) in the dispenser. Some medication containers (not shown) can be equipped with RFID chips (not shown) that can contain information on the medication in the container. Such RFID chips can be placed on or built into the container when the container is manufactured, or at a later time, such as when a pharmacist provides the container containing medication to the patient. The RFID chip in such a container can be a standard MIFARE® RFID chip, or any other type of RFID chip or tag. A drug manufacturer, physician, and/or pharmacist can store information on the RFID chip. For example, the RFID chip can include the date and time of packing a medication in the container, the content of the container, the drug type and number of pills, the expiration date of the medication, a unique identification number, patient medication intake times, length of the course of treatment, pharmacist license number, prescribing physician license number, proper storage temperature and humidity ranges, and/or other information pertaining to the solid preparation contained in the container. Optionally, similar information can be stored in the memory of the dispenser or other device rather than in an RFID chip, for example by the pharmacist who dispenses the medication, a physician, or a patient.

The RFID reader can be used to read this information from the RFID chip attached to the container when the dispenser or other device (e.g. a lid) containing the electronic circuitry 2500 is attached to the container. The information can then optionally be stored in the memory 2504, and used by the processor 2502 for a variety of purposes. For example, if the dispenser or medication container includes a display, such as the display 2514, the information read by the RFID reader can be displayed. This can reduce the risk of taking the wrong medication or medication that has passed its “use by” date. The risk of taking the wrong medication can be especially pronounced when a patient needs to take two or more types of medication. When an RFID reader in the dispenser or medication container is used with an RFID chip on the container, the patient is able to read on the display which of his medications is contained in the container. This can be particularly useful when the labeling of the container has faded, for example due to frequent use or contact with water or solvents. The processor 2502 can use the information read from an RFID chip on the container for purposes such as displaying the drug contained in the container, determining when the container is almost empty (based on pill count), automatically programming the times that the solid preparation should be dispensed or accessed so that the processor 2502 can generate alarms at the proper times, producing a warning when a medication has expired or has been stored at an unacceptable temperature and/or humidity level, preventing a user from dispensing or accessing the solid preparation at the wrong times, after it has expired, after a course of treatment has been completed, if improper temperature and/or humidity conditions can have affected the medication, and other uses for such information.

Additionally, optionally, the RFID reader can also store information back into the RFID chip on the container. This means that compliance information can be available in the container chip when it is returned to the pharmacist, for example for a refill.

Referring now to FIG. 14, a system 2600 for communicating with a dispenser or medication container 2601 is described. A docking station 2602 can be used for electronic data communication and electronic data transfer between the dispenser or medication container and a computer (not shown) or other communication device (not shown). Additionally, optionally, the docking station 2602 can be used to recharge a rechargeable battery in the dispenser or medication container.

Optionally, the docking station 2602 can include a wired connection 2604, such as a USB connection or other wired connection for transferring data between the docking station 2602 and a computer or other communication device. Optionally, the docking station 2602 can include a wireless communication device (not shown) to allow the docking station 2602 to communicate via a wireless connection, such as through a cellular network, a wireless wide area network, or a wireless local area network. The docking station can be powered using an AC mains adapter 2606, or through power received over the wired connection 2604.

The docking station 2602 can be also equipped with a electronic reader-writer device (described below), for reading and writing data from the dispenser or medication container. Optionally, where the dispenser or medication container is able to communicate directly with a wide area network or cellular network, or where the communication is handled by a portable reader, such as a mobile phone equipped with an NFC reader, the docking station 2602 might not be needed for the dispenser or medication container to communicate its data.

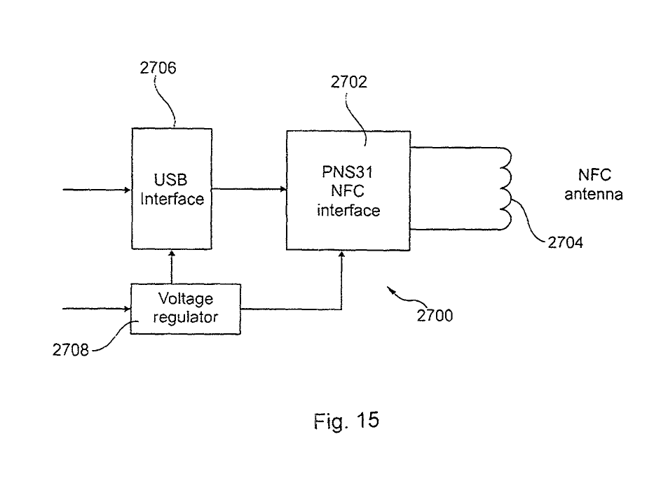

FIG. 15 shows a block diagram of an electronic reader-writer device 2700 suitable for use in the docking station 2602 of FIG. 14. The reader-writer device 2700 includes a second transceiver 2702 with a second antenna 2704 for communicating with the first transceiver 2510 in the dispenser, as shown in FIG. 13. When used with the reader-writer device 2700 in a docking station, the dispenser or medication container can preferably use a low power, short range communication technology, such as Near Field Communication (NFC), Bluetooth®, or ZigBee®. Other communications technologies suitable for longer range wireless communications can also be used, such as Wi-Fi or other wireless local area network (WLAN) technology. Of course, the communication technology used by the reader-writer should be compatible with the communication technology used by the dispenser or medication container. Alternatively, a physical electrical connection between the dispenser or medication container and the docking station could be used, assuming that the dispenser or medication container includes an appropriate interface. For example, if the dispenser has a USB interface, it can be possible to connect it to the docking station (or directly to a USB-equipped external computer) using the USB interface. A physical interface, such as a USB interface, can also be useful for charging a rechargeable battery in the dispenser.

The reader-writer device 2700 also can include a wired connection interface 2706. The wired connection interface 2706 can be, for example, a USB interface through which the reader-writer device connects the docking station to an external computer system. Other types of wired connections, such as a serial connection or a wired Ethernet connection could also be used.

The reader-writer device 2700 can be powered from an AC adapter (not shown) through a voltage regulator 2708. Alternatively power can be received from other sources, such as through the wired connection interface 2706.

Once the data are transferred from the dispenser or medication container to an external computer (through a docking station, such as the docking station 2602, shown in FIG. 14, when the dispenser is unable to communicate directly with the external computer), the external computer can transfer the data to a remote computer via a wide area network, such as the Internet. The dispenser or medication container can also receive data, such as revised expiration date data based on temperature and/or humidity readings, or proper temperature and/or humidity ranges for storage of the medication via a wide area network through an external computer (and, possibly a docking station). Further, programming or instructions for the electronic circuit 2500 of the dispenser, as shown in FIG. 13, can be sent from a computer at a remote location, and communicated to the dispenser via the Internet or other wide area network. The remote computer may, for example, be accessible by a physician, pharmacist, or other medical professional who is overseeing the therapy compliance of the patient who is using the dispenser or medication container. It will be understood that optionally, where the dispenser or medication container includes wide-area networking or cellular communication capabilities, the dispenser can be able to connect to the Internet and/or the remote computer system without using an external computer or docking station to establish the connection. It will also be understood that optionally, a mobile device, such as an NFC-equipped mobile telephone can be used to communicate between the remote computer and the dispenser.

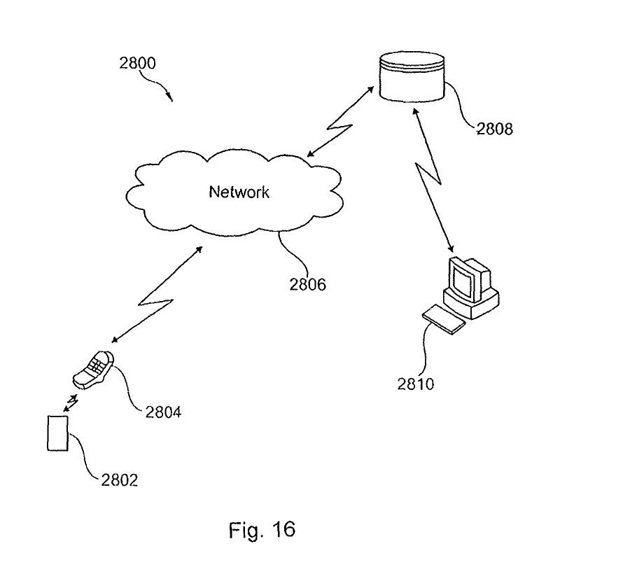

Such a system is shown in FIG. 16. The system 2800 of FIG. 16 includes one or more dispensers (or medication containers) 2802, which include the electronic circuitry 2500 as shown in FIG. 13. For purposes of illustration, these dispensers include NFC communication circuitry, which allows them to transfer data between a dispenser 2802 and an NFC-equipped mobile telephone 2804. The NFC-equipped telephone 2804 can wirelessly communicate via a wide area network 2806, such as a cellular communication network or the Internet with a remote database 2808, which collects and stores information from the dispenser(s) 2802. The remote database 2808 can be accessed (through the wide area network 2806 or a different wide area network) by a remote computer 2810, which can also remotely send instructions to the dispenser(s) 2802 through the wide area network 2806 and the mobile telephone 2804.

It will be understood that the communication path can be somewhat different, depending on the technology used. For example, if no NFC-equipped mobile phone is available, the dispenser can use a docking station (not shown) connected to a computer (not shown) to communicate with the remote database 2808 and/or the remote computer 2810. Alternatively, optionally, the dispenser can be able to directly connect to the wide area network, and communicate with the remote database 2808 and/or the remote computer 2810 without using an NFC-equipped mobile telephone or a docking station.

As can be seen in FIG. 16, the therapy compliance monitoring and communication equipment provided can be mobile. The dispenser 2802 can be arranged for monitoring the therapy compliance of a patient, and for remotely allowing or disabling the dispensing of a solid preparation, to help ensure therapy compliance. Wired and/or wireless communications can be used to report therapy compliance, and the temperature and/or humidity at which medications are being stored to the remote computer 2810, which can be used by a physician, pharmacist, or other medical caregivers to monitor compliance and other conditions, such as temperature and/or humidity of the medication. Additionally, administration of therapy can be controlled or adjusted from the remote computer 2810, depending on the information received. Further, as can be seen, in addition to the Internet, other communication technologies can be used in the remote surveillance and control of therapy compliance, including mobile platforms, such as the mobile telephone 2804, and the like.

When a container with a solid preparation is issued by a pharmacist, the dispenser 2802 or other device containing the electronic circuitry and temperature and/or humidity detectors is put in place on the container. Alternatively, the circuitry and sensors can be built into the container into which the pharmacist places the medication. The dispenser 2802 has a built-in clock/calendar so that when a solid preparation, such as a pill or tablet is dispensed, the date and time of this event are stored in a memory in the dispenser 2802. Similarly, the times of recording temperature and or humidity readings can be stored. In dispenser embodiments, the dispenser 2802 can optionally be programmed so that the solid preparation can only be dispensed at pre-programmed times, depending on the medication prescribed, and the instructions of the physician and/or pharmacist. This can prevent a patient from taking too many doses, since the dispenser 2802 can be blocked after a dosage is taken, and will only dispense a further dose when the next dosage should be taken. It should also be noted that this option of programming the dispenser provides the opportunity to register and regulate a combination therapy, whereby more than one type of medication must be taken, as will be described in greater detail below.

Next, the date and time stamp at which a dose was dispensed, and/or other information, such as temperature and/or humidity data are transferred over the wide area network, which can be a mobile telephone network, such as GSM or GPRS, to the patient's record in the remote database 2808. As shown in the figure, optionally, this transfer can be accomplished by reading the data from the dispenser using a Near Field Communication (NFC) mobile phone 2804, or by using another gateway for conversion of data from NFC or Bluetooth® devices into SMS and GPRS data. It will be understood that other communication options, as described above are also possible. Other data collected by the dispenser can also be transferred along with the compliance data, or as separate transmissions. For example, data concerning the temperature and humidity of the stored medication can be transferred. These data can indicate whether the pills, capsules, or other solid preparations are being stored in appropriate conditions. This information can be used to send the patient and/or the pharmacist or physician a warning if the medication is being stored at an inappropriate temperature or humidity. This data could also be used, for example, to dynamically adjust the expiration date of a medication, depending on its storage conditions, or to prevent a patient from taking medications which could become dangerous if stored for a period of time in an inappropriate manner. Other information, such as the battery status can also be transferred. This data may, for example, be used to warn the patient or pharmacist if a non-rechargeable battery in the dispenser device will need to be replaced.

The patient record in the database 2808 can contain various kinds of patient information, including the therapy compliance records for the patient received from one or more dispensers. This information can be securely accessed by physicians, pharmacists, or other authorized medical caregivers from a remote computer 2810 over a wide area network, such as the Internet. The compliance data can be correlated and analyzed in the remote database 2808 or on the remote computer 2810, and if mal-compliance or noncompliance are detected, the patient can be warned, for example via an SMS service or the like. Optionally, when noncompliance or mal-compliance are detected, a call centre, pharmacist, and/or care organization can receive an instruction to call the patient to discuss his mal- or noncompliance.

Optionally, a dispenser can also communicate with another dispenser, either directly, through a docking station, or through a network. An advantage of such a dispenser can be that it is possible to regulate the order in which two or more medications are taken. For example, in AIDS treatment, a combination of drugs can be prescribed, which need to be taken in a strict order and according to a strict time schedule. For example, the prescription schedule can specify that a first medication should be taken first, followed within one hour by a second medication. If the patient forgets that he has already taken the required dosage of the first medication, he can try to “correct” this by taking another dose of the first medication. Such noncompliance can have serious effects on the health of the patient and on the effectiveness of the treatment.

By communicating with each other, the dispensers can reduce this problem. Using the above-described example, a first dispenser for a container containing the first medication can block further dispensing of the first medication until it receives a communication indicating that a second dispenser for a container containing the second medication has dispensed a dose of the second medication. Thus, a new dose of the first medication can only be taken after the required dose of the second medication has been taken. The time for taking the second medication can be set by the second dispenser receiving a communication indicating that the first medication has been dispensed by the first dispenser, causing the second dispenser to set a buzzer or other alarm feature to provide a warning one hour later that the second medication should be taken. By use of dispensers that are able to communicate with each other, according to an embodiment of the invention, a strict medication regime can be followed with reduced effort by the patient and with an increased rate of compliance.

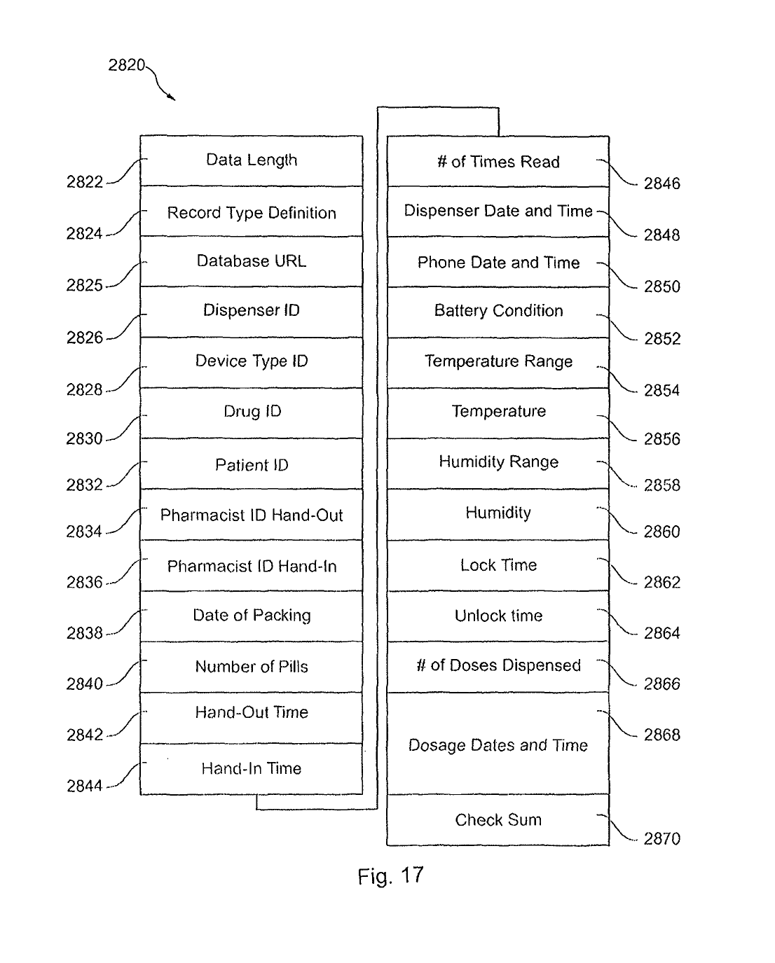

It should be noted that in accordance with various embodiments of the invention, communication between the dispensers can be achieved directly between the dispensers, or via an indirect method. For example, the dispensers can communicate through a base station, or through a wireless network. Also, the dispensers could communicate indirectly through a database, such as the remote database 2808 shown in FIG. 17, or through another computer or communication device that receives and sends communications to dispensers in accordance with various embodiments of the invention.

In an embodiment of a system such as is shown in FIG. 16, in which the dispenser communicates with a mobile phone, the mobile phone can handle various functions of the system, such as alarming functions, displaying compliance and other information to a patient, interacting with the user to send commands to the dispenser, and/or facilitating communications between a patient and pharmacist and/or physician. For example, instead of generating a beeping noise from the dispenser when it is time to take medication, the dispenser can cause the mobile phone with which it communicates to generate a noise or send a message, warning the patient (i.e., the owner of the mobile phone) that it is time to take medication. As a further example, the dispenser can instruct the mobile phone to warn the patient that the medication is almost depleted. When this warning is received the mobile phone can be configured (e.g., via special purpose software) to warn the patient, provide an option to automatically order refill medication, and/or tie into other services, such as mapping services, to direct the patient to a nearby pharmacy. If it is determined that the patient's compliance is poor, or that the medication is not having its intended effect (e.g., due to data sent from physiological monitoring equipment (not shown)), the database 2808 or the medication dispenser can instruct the mobile phone to warn the user, and can provide options to call a physician or schedule an appointment. Warnings provided by mobile phones can use a wide variety of sounds available on mobile phones, or can be delivered via voice or text message. Communication between the mobile phone and the database can be handled using the mobile phone's communication capabilities, e.g., through GPRS (General Packet Radio Service) or other mobile data communications services. Because of the widespread use and ownership of mobile phones and mobile phone services, a mobile phone can provide a widely-available interface to medication dispensing systems and to related services.

At present, an increasing number of mobile phones are able to communicate wirelessly with devices such as the medication dispenser using communications devices and protocols in accordance with the NFC (Near Field Communication) standard. In accordance with the invention, the data collected by a medication dispenser can be communicated using a specialized Record Type Definition within the Near Field Communication Data Exchange Format. An example embodiment of such a Record Type Definition is shown in FIG. 17.

As seen in FIG. 17, a dispenser data stream 2820 includes the following fields:

1. Data length field 2822, for specifying the number of bytes of information in the record.

2. RTD (Record Type Definition) indication number field 2824, which can be used to identify the RTD of the record as a dispenser datastream record.

3. URL of the database server field 2825, used for specifying the URL (Uniform Resource Locator) of the database server where the patient and/or compliance data are stored.

4. Dispenser ID field 2826, used for a unique identifier for each dispenser, including a manufacturer ID, a date of manufacturing, and a code for the place of manufacturing.

5. Device type ID field 2828, used to specify information identifying the type of the dispenser.

6. Drug ID of the content field 2830, used to specify information identifying the drug contained in the dispenser.

7. Patient ID field 2832, used to specify information identifying the patient (e.g., a patient ID number).

8. Pharmacist ID Hand-out field 2834, used for information identifying the pharmacist who handed out the dispenser and/or the drug contained in the dispenser.

9. Pharmacist ID Hand-in field 2836, used for information identifying the pharmacist to whom the dispenser was handed in, and/or to whom the dispenser should be handed in.

10. Date of packing field 2838, used for the date on which the dispenser was last filled. Alternatively, this field can be used to indicate the expiration date of the drugs in the dispenser. Optionally, this field can contain both the date of packing, and the expiration date.

11. Number of pills packed field 2840, used for the number of pills originally placed in the dispenser. In alternative embodiments, in which a blister pack is used, this field can indicate the number of blisters that are filled with pills or capsules. In alternative embodiments, such as liquid dispensers, injectables, or inhalers, this field can be used to indicate the number of doses, amount of liquid, etc., as appropriate for the type of dispenser.

12. Hand-out time of the dispenser field 2842, used to indicate the time (and date) at which the dispenser was handed out.

13. Hand-in time of the dispenser field 2844, used to indicate the time (and date) at which the dispenser was handed in or returned.

14. Number of times information read field 2846, used to indicate the number of times that information has been read from the dispenser by the mobile phone.

15. Dispenser date and time field 2848, indicating the current date and time according to the dispenser clock.

16. Phone date and time field 2850, indicating the date and time of the clock on the telephone that read the data.

17. Battery condition field 2852, indicating the state of the battery.

18. Temperature range field 2854, indicating the minimum and maximum temperature over the time from the hand-out time to the current time (if the current time is prior to the hand-in time) and/or the hand-in time (if the current time is after the hand-in time).

19. Temperature field 2856, indicating the current temperature measurement.

20. Humidity range field 2858, indicating the minimum and maximum humidity over the time from the hand-out time to the current time and/or the hand-in time.

21. Humidity field 2860, indicating the current humidity measurement.

22. Lock time field 2862, indicating a time at which the dispenser was locked, such that no dose can be dispensed. Optionally, this field can be used to indicate a time over which the dispenser is to remain locked.

23. Unlock time field 2864, indicating a time at which the dispenser was (or is to be) unlocked. Optionally, this field can be used to indicate a period of time over which the dispenser should be unlocked, such that a dose can be dispensed.

24. Number of doses dispensed field 2866, indicating the number of doses that have been dispensed. For example, in a pill dispenser, such as is shown above, this would indicate the number of pills that have been dispensed. In a liquid dispenser, it would indicate the number of doses of the liquid that have been dispensed.

25. Dosage dates and times field 2868, indicating the dates and times at which doses were dispensed. Generally, this field can include the date and time for each of the doses that have been dispensed since the hand-out time of the dispenser. Optionally, this can have an upper limit, depending on the memory available in the dispenser. For example, optionally, this field can provide the date and time for up to the last 200 doses that were dispensed.

26. Check sum field 2870, containing a check sum verifying that no data have been lost or altered. Optionally, this field can contain a cyclic redundancy check code for the rest of the record.

It will be understood that the record type definition discussed above could be varied, depending on the dispenser and sensors available. For example, in embodiments where temperature and/or humidity are not measured, the fields for these measurements could either be left empty, or a slightly varied record type definition omitting these fields could be used. It will also be recognized that the order and exact content of the fields can be altered. The content of the record can be sent between the dispenser and the mobile phone and/or between the mobile phone and database in an encrypted form. It will further be recognized that although the record type definition has been described as a Near Field Communication record type definition, other short-range communications systems, such as Bluetooth®, could be used, and a similar record type definition (altered to fit the requirements of the communication system) could be used in such systems.

Thus, in accordance with embodiments of the invention, a medication container can be provided. The medication container can be equipped with an electronic temperature sensor and/or an electronic humidity sensor positioned within the container such that the temperature and/or humidity within the container can be measured. The medication container can be further equipped with electronic circuitry that receives readings from the electronic temperature sensor and/or the electronic humidity sensor, and stores and/or transmits the readings to an external device. Optionally, the medication container can be a dispenser.

The temperature sensor in any of the preceding embodiments can be a thermistor or other resistance temperature detector. The humidity sensor in any of the preceding embodiments can be a capacitive humidity sensor, a resistive humidity sensor, or a thermal conductivity humidity sensor.

The medication container of any of the preceding embodiments can include an alarm device, such as a buzzer or vibration device. An alarm can be produced when the temperature sensor and/or the humidity sensor indicates that the medication contained in the container is being stored at a temperature and/or humidity that is outside of an acceptable temperature and/or humidity range. The acceptable temperature and/or humidity range will depend on the medication stored in the container.

In the medication container of any of the preceding embodiments, the circuitry can receive information and/or commands from an external source. This information can include an acceptable temperature and/or humidity range for the medication contained in the medication container and/or an expiration date for the medication in the container calculated based on the temperature and/or humidity readings sent to the external device. The commands received from the external source can include a command to alert the user that the temperature and or humidity readings sent to the external device are outside of an acceptable temperature and/or humidity range. Additionally, the medication container can include a blocking device that prevents access to the medication stored in the container, and the commands received from the external source can include a command to activate the blocking device to prevent access to the medication if the medication has been stored at a temperature and/or humidity outside of an acceptable temperature and/or humidity range.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practising the claimed invention, from a study of the drawings, the disclosure, and the appended claims. In the claims, the word “comprising” does not exclude other elements or steps, and the indefinite article “a” or “an” does not exclude a plurality. A single processor or controller or other unit can fulfill the functions of several items recited in the claims. The mere fact that certain measures are recited in mutually different dependent claims does not indicate that a combination of these measures cannot be used to advantage. Any reference symbol in the claims should not be construed as limiting the scope.

### LIST OF REFERENCE CHARACTERS

21 Tablet dispenser and bottle assembly
23 Bottle
25 Dispenser
27 Mouth
29 Thread
31 Bead
33 Flange
35 Wall
37 Reservoir
39 Dispensing funnel or inlet portion (of 25)
41 Outlet portion (of 25)
43 Helical dispensing screw or tablet transporter
44 rotation drive
45 Rotation drive stationary portion
47 Rotation drive rotating portion
49 Anti-bridging sweep (of 25)
51 Body or housing (of 25)
53 Spring
55 Slide surface
57 Tab assembly
59 Electronics mounting disk
61 Battery holder
63 Energy reservoir
65 Cover
67 Inlet path or inlet opening
69 Guide surface or feed
71 Tablet
73 Tablet
75 Axial facing helical surface
77 Radial facing helical surface
79 Collar or Groove (of 39)
81 Gasket
83 Tablet transfer component
85 Shoulder
87 Outlet path or outlet opening
89 Outlet chute
91 flange (of 83)
93 spindle (of 43)
95 Groove (of 51)
97 Groove (of 51)
99 Third threaded portion
101 Fourth threaded portion
103 Ear (of 41)
105 Ear (of 41)
107 Pocket (of 43)
109 Chute or transporter opening (of 43)
110 child resistance component
111 Child resistant interlock
113 Abutment
115 Aperture
117 Finger (of 49)
119 Finger (of 49)
121 Hub (of 49)
123 Root (of 49)
125 Second spindle (of 43)
127 Opening (in 55)
129 Chute (of 81)
131 Surface (of 43)
135 Tablet (at outlet)
2500 Electronic circuit
2502 Processor
2504 Memory
2506 Battery
2508 Power regulator
2510 First transceiver
2512 First antenna
2514 Optional display
2516 Display driver
2518 Optical detector
2520 First switch
2522 Second switch
2524 Third switch
2526 Fourth switch
2528 Fifth switch
2530 Buzzer
2532 Vibration device
2534 Blocking mechanism
2536 Humidity sensor
2538 Temperature sensor
2600 System
2601 Dispenser or medication container
2602 Docking station
2604 Wired connection
2606 AC mains adapter
2700 Reader-writer device
2702 Second transceiver
2704 Second antenna
2706 Wired connection interface
2708 Voltage regulator
2800 System
2802 Dispensers or medication containers
2804 NFC-equipped mobile telephone
2806 Wide area network
2808 Remote database
2810 Remote computer
2822 Data length field
2824 Indication number field
2825 Database server field
2826 Dispenser ID field
2828 Device type ID field
2830 Drug ID of the content field
2832 Patent ID field
2834 Pharmacist ID hand-out field
2836 Pharmacist ID hand-in field
2838 Date of packing field
2840 Number of pills packed field
2842 Hand-out time of the dispenser field
2844 Hand-in time of the dispenser field
2846 Number of times information read field
2848 Dispenser date and time field
2850 Phone date and time field
2852 Battery condition field
2854 Temperature range field
2856 Temperature field
2858 Humidity range field
2860 Humidity field
2862 Lock time field
2864 Unlock time field
2866 Number of doses dispensed field
2868 Dosage dates and times field
2870 Check sum field

1. A tablet dispenser for dispensing tablets from a bottle, comprising:
A. an inlet portion with an inlet opening for receiving a tablet from the bottle;
B. an outlet portion with an outlet opening for dispensing the tablet;
C. a tablet transporter situated between the inlet portion and the outlet portion; and
D. a rotation drive for rotating the tablet transporter with respect to the inlet portion and the outlet portion;
E. wherein the tablet transporter has a transporter opening for receiving the tablet from the inlet opening in a receiving position
F. wherein the rotation drive is adapted to rotate the tablet transporter from the receiving position to a dispensing position, thereby transporting the tablet with the transporter opening to the outlet opening.

2. The tablet dispenser according to claim 1,
wherein the rotation drive is operable by pushing the inlet portion and the outlet portion toward each other.

3. The tablet dispenser according to claim 1,
wherein the rotation drive comprises a screw and a nut transforming a linear movement of the inlet portion and the outlet portion with respect to each other into a rotational movement of the tablet transporter.

4. The tablet dispenser according to claim 1, further comprising: a tablet transfer component for supporting the tablet during the transport from the receiving position to the dispensing position;
wherein the tablet transporter is lifted from the tablet transfer component during the rotational movement.

5. The tablet dispenser according to claim 1, wherein, at least in the receiving position, a moisture tight seal between the bottle and the tablet dispenser is provided.

6. The tablet dispenser according to claim 1, further comprising: a spring being compressed during the movement of the tablet transporter from the receiving position to the dispensing position; wherein the spring is adapted to move the tablet transporter from the dispensing position to the receiving position.

7. The tablet dispenser according to claim 1, wherein the inlet portion comprises a desiccant component for absorbing moisture entering the bottle from the tablet dispenser.

8. The tablet dispenser according to claim 1, further comprising: a collar adapted to be connected to a pharmaceutical bottle comprising the tablets.

9. The tablet dispenser according to claim 1, further comprising: an anti-bridging device positioned to sweep and block an entrance to the receiving opening when the rotation drive is operated.

10. The tablet dispenser according to claim 1, further comprising: a child resistant interlock having a normally locked position for preventing a tablet from being dispensed and an unlocked position for allowing a tablet to be dispensed;
wherein the child resistant interlock, when in its normally locked position, prevents the inlet portion and the outlet portion from being pushed together.

11. (canceled)

12. A method of dispensing tablets with a tablet dispenser, comprising the steps of:
A. attaching a bottle storing tablets in a bulk to the tablet dispenser;
B. receiving, in an inlet opening of an inlet portion of the tablet dispenser, a tablet from the bottle, wherein the tablet falls into a transporter pusher of a tablet transporter being in a receiving position;
C. rotating, by a rotation drive, the tablet transporter from the receiving position to a dispensing position, wherein the tablet falls into an outlet opening of an outlet portion of the tablet dispenser, when the tablet transporter arrives at the dispensing position;
D. dispensing the tablet from the outlet opening.

13. A tablet dispenser for dispensing tablets from a bottle, comprising:
A. an inlet portion perforated by an inlet path, the inlet path positioned for receiving a tablet from a bottle;
B. an outlet portion perforated by an outlet path, the outlet path being non-collinear with the inlet path and positioned for dispensing a tablet;
C. a helical dispensing screw disposed between the inlet portion and the outlet portion and configured to transport a tablet from the inlet path to the outlet path; and
D. a rotation drive operable by pushing at least one of the inlet portion and the outlet portion toward the other and configured to rotate the dispensing helical dispensing screw with respect to the outlet portion for transporting a tablet from the inlet path to the outlet path.

14. The tablet dispenser of claim 13, further comprising a child resistant interlock having a normally locked position for preventing a tablet from being dispensed and an unlocked position for allowing a tablet to be dispensed.

15. The tablet dispenser of claim 14, in which the child resistant interlock prevents the rotation drive from operating when in its normally locked position and releases the rotation drive when in its unlocked position.

16. The tablet dispenser of claim 14, in which the child resistant interlock, when in its normally locked position, prevents the inlet portion and the outlet portion from being pushed together.

17. The tablet dispenser of claim 14, in which the child resistant interlock comprises opposed apertures in the outlet portion defining outlet abutments facing the inlet portion and resilient tabs extending from the inlet portion into the apertures and having inlet abutments that normally engage the outlet abutments, the resilient tabs being movable against their resilience out of engagement with the outlet abutments to permit the inlet portion and the outlet portion to telescope toward each other.

18. The tablet dispenser of claim 13, in which the rotation drive comprises a first threaded portion secured to one of the inlet portion and the outlet portion and a second threaded portion secured to the helical dispensing screw, the first and second threaded portions engaging to rotate the helical dispensing screw when the first and second threaded portions are pushed together.

19. The tablet dispenser of claim 18, in which the rotation drive comprises a third threaded portion secured to the other of the inlet portion and the outlet portion and a fourth threaded portion secured to the helical dispensing screw for rotatably capturing the helical dispensing screw between the inlet portion and the outlet portion.

20. The tablet dispenser of claim 13, in which the inlet portion comprises a feed for feeding tablets to the inlet path.

21. The tablet dispenser of claim 13, further comprising a spring between the inlet and outlet portions biasing the inlet and outlet portions away from each other.

22. The tablet dispenser of claim 13, in which the inlet portion comprises a threaded collar to receive the threaded mouth of a pharmaceutical bottle containing tablets to be dispensed.

23. The tablet dispenser of claim 13, further comprising a pharmaceutical bottle on which the tablet dispenser is mounted.

24. The tablet dispenser of claim 13, further comprising an external guide surface of the inlet portion leading up to the inlet path for directing tablets toward the inlet path.

25. The tablet dispenser of claim 24, in which the guide surface comprises an axially facing helical surface.

26. The tablet dispenser of claim 24, in which the guide surface comprises a radially facing helical surface.

27. The tablet dispenser of claim 24, in which the guide surface is further defined by the wall of a bottle when a bottle is mounted on the tablet dispenser.

28. The tablet dispenser of claim 13, further comprising a gasket to seal the contents of a bottle mounted on the tablet dispenser against the transport of moisture into the bottle.

29. The tablet dispenser of claim 28, in which the helical dispensing screw seats against the gasket to seal or reseal between uses and withdraws from the gasket when the helical dispensing screw rotates.

30. The tablet dispenser of claim 13, further comprising a desiccant for absorbing moisture entering the bottle.

31. The tablet dispenser of claim 13, further comprising an anti-bridging device movable by the rotation drive and positioned to sweep and block the entrance to the inlet path when the rotation drive is operated.

32. The tablet dispenser of claim 31, in which the anti-bridging device comprises two radially extending fingers circumferentially sweeping the entrance to the inlet path when the rotation drive can be operated.
